(19) United States
(12) Patent Application Publication
(10) Pub. No.: US 2009/0086219 A1
(43) Pub. Date: Apr. 2, 2009

(54) DOCUMENT PROCESSING APPARATUS, DOCUMENT PROCESSING METHOD AND COMPUTER-READABLE MEDIUM

(76) Inventor: Kanji NAGASHIMA, Kanagawa-ken (JP)

Correspondence Address: BIRCH STEWART KOLASCH & BIRCH, PO BOX 747, FALLS CHURCH, VA, 22040-0747, US

(21) Appl. No.: 12/238,259

(22) Filed: Sep. 25, 2008

(30) Foreign Application Priority Data
Sep. 28, 2007 (JP) 2007-256740

(51) Int. Cl. G06K 15/00

(52) U.S. Cl. 358/1.5

(57) ABSTRACT

A document processing apparatus has: a reading device which optically reads in a printed document on which original information has been printed, to obtain a read image; an analysis device which analyses the read image obtained by the reading device and classifies each part of the read image into the original information and a blank portion; an information processing device which processes the original information to generate additional recording information; an arrangement device which determines arrangement, on the printed document, of the additional recording information which is to be recorded additionally onto the printed document, according to analysis result of the analysis device; and a printing device which additionally records the additional recording information onto the printed document according to the arrangement of the additional recording information determined by the arrangement device.

### BACKGROUND OF THE INVENTION

1. Field of the Invention

The present invention relates to a document processing apparatus, document processing method and computer-readable medium for generating and printing valuable information relating to the contents of a printed document.

2. Description of the Related Art

Printers which are capable of printing various types of information, such as text information, photographs, figures, and the like, have been proposed. One commonly used example of a printer of this kind is an inkjet printer which prints information onto a medium such as paper by using an ink ejection head having a plurality of nozzles that eject ink, for instance. Printers which use various other methods, such as an electrophotographic method (dry method) or a thermal transfer method, apart from an inkjet method, have also been proposed.

Furthermore, Japanese Patent Application Publication No. 6-243162 and Japanese Patent Application Publication No. 8-3 0624 each teach a machine translation apparatus which optically reads in a paper document that has been printed, performs character recognition and translation and then prints the original document and the translation result onto separate paper.

Japanese Patent Application Publication No. 2000-3265 83 teaches technology for recording a plurality of X-ray images onto one sheet in an X-ray image recording apparatus. By recording onto the sheet a block-shaped figure which indicates how many X-ray images are recorded onto what parts of a sheet, together with the X-ray images, each time a recording is made, then the subsequent process of adding X-ray images is made easier.

Japanese Patent Application Publication No. 11-149486 teaches technology whereby searched information is displayed together with a leading line in an electronic dictionary. This technology relates to information searching and does not relate to the reading out of information from a print medium.

Japanese Patent Application Publication No. 2006-334835 teaches a printer in which, when a printed object is examined after printing by ejecting ink from nozzles, if omitted portions are found, then ink is ejected from normal nozzles onto these omitted portions. In other words, an image containing printing defects is corrected to print the original image that it is originally intended to record.

However, it is difficult to achieve simultaneously the automatic generation and printing of valuable information which aids understanding of the contents of printed documents of various types, and the provision of an apparatus having good environmental characteristics which does not consume new print medium.

Concerning the apparatuses disclosed in Japanese Patent Application Publication No. 6-243162 and Japanese Patent Application Publication No. 8-30624, although it is possible to print translation results onto a new print medium which is separate from the print medium on which the original document is printed, it is not possible to append a translation result onto the actual print medium on which the original document is printed.

Japanese Patent Application Publication No. 2000-326583, Japanese Patent Application Publication No. 11-149486 and Japanese Patent Application Publication No. 2006-334835 do not make any mention of technology which relates to appending information to the same printed document on which information has already been printed, by making effective use of the restricted blank margins of the printed document.

Consequently, if it is wished to present valuable information relating to the contents of the printed document to the user, it is necessary to print valuable information of this kind onto a new medium, and hence there is concern that the volume of documents increases, a new medium is consumed, and hence environmental suitability is poor.

### SUMMARY OF THE INVENTION

The present invention has been contrived in view of these circumstances, an object thereof being to provide a document processing apparatus, a document processing method and a computer-readable medium having good environmental suitability, whereby valuable information relating to the contents of a printed document can be presented to a user, as well as being able to prevent increase in the volume of printed documents and the consumption of new media.

In order to attain an object described above, one aspect of the present invention is directed to a document processing apparatus comprising: a reading device which optically reads in a printed document on which original information has been printed, to obtain a read image; an analysis device which analyses the read image obtained by the reading device and classifies each part of the read image into the original information and a blank portion; an information processing device which processes the original information to generate additional recording information; an arrangement device which determines arrangement, on the printed document, of the additional recording information which is to be recorded additionally onto the printed document, according to analysis result of the analysis device; and a printing device which additionally records the additional recording information onto the printed document according to the arrangement of the additional recording information determined by the arrangement device.

According to this aspect of the invention, the beneficial information relating to the contents of the printed document can be recorded additionally onto the actual printed document itself by an automatic process and thus presented to the user, and furthermore increase in the volume of printed documents and consumption of media can be prevented.

Desirably, the document processing apparatus further comprises: an overcoating device which erases the original information on the printed document by overcoating; and a control device which implements control to erase the original information on an original print surface area of the printed document by means of the overcoating device and reprint the original information over a reprint surface area of the printed document that is smaller than the original print surface area by means of the printing device in such a manner that the blank portion is enlarged, if the blank portion on the printed document is insufficient for the additional recording information.

According to this aspect of the invention, it is possible to achieve the additional recording onto the actual printed document even in cases where there is insufficient blank space on the printed document.

Desirably, when the original information includes a portion to be reprinted and a portion to be not reprinted, the arrangement device aligns a line start position and a line width of the original information between the portion to be reprinted and the portion to be not reprinted.

According to this aspect of the invention, it is possible to provide a printed document that is easy to read, even if the original information on the printed document is rearranged in cases where there is insufficient blank space on the printed document.

Desirably, the overcoating device comprises a liquid ejection head having a plurality of ejection ports ejecting an overcoating liquid.

According to this aspect of the invention, it is possible to carry out an overcoating process onto the minimum necessary region, even if the original information on the printed document is rearranged in cases where there is insufficient blank space on the printed document.

Desirably, the printing device uses a liquid that has an erasable color on the printed document, to print the additional recording information.

According to this aspect of the invention, it is possible to return the printed document to a state without any additional recording, when the contents which have been additionally recorded onto the printed document are no longer necessary.

Desirably, the overcoating device and the printing device use a liquid that has an erasable color on the printed document, to perform additional recording of the additional recording information.

According to this aspect of the invention, it is possible to return the printed document to a state without any additional recording or overcoating, when the contents which have been additionally recorded onto the printed document are no longer necessary.

Desirably, the printing device fills the additional recording information and a peripheral region of the additional recording information with the liquid having an erasable color, before erasure of the additional recording information.

According to this aspect of the invention, it is possible to make the additional recording contents difficult for a third party to read, after the contents recorded additionally onto the printed document have been erased.

Desirably, the printing device uses an ink which can be detached from the printed document after additional recording, to record the additional recording information.

According to this aspect of the invention, it is possible to return the printed document to a state which is closer to the original state of the document when the contents recorded additionally onto the printed document have been detached and erased, and it is also possible to make the additional recording contents more difficult for a third party to read after detachment and erasure.

Desirably, the printing device uses an ink which becomes visible when the ink is radiated by ultraviolet light after additional recording, to record the additional recording information.

According to this aspect of the invention, it is possible to make the additional recording contents difficult for a third party to read when in an unaltered recorded state on the printed document.

Desirably, the document processing apparatus further comprises: a determination device which determines medium type or surface quality of the printed document; and a switching device which switches type of liquid used for recording of the additional recording information, according to determination result of the determination device.

According to this aspect of the invention, it is possible to fix the additional recording contents more reliably when performing additional recording onto the printed document.

Desirably, the document processing apparatus further comprises: a determination device which determines medium type or surface quality of the printed document; an under layer treatment liquid deposition device which deposits, onto a surface of the printed document, an under layer treatment liquid to enhance fixing properties of a liquid used for printing of the additional recording information; and a switching device which switches whether or not to deposit the under layer treatment liquid onto the surface of the printed document, according to determination result of the determination device.

According to this aspect of the invention, it is possible to fix the additional recording contents more reliably in accordance with the medium of the print document when performing additional recording onto the printed document.

Desirably, the document processing apparatus further comprises an automatic sheet feeder and a page turning apparatus, wherein if the printed document is a single sheet document, then the automatic sheet feeder feeds the printed document to a reading position of the reading device, whereas if the printed document is a bound medium, then the page turning apparatus turns pages of the bound medium in such a manner that a target page is set to a state where it can be read by the reading device.

According to this aspect of the invention, additional recording can be carried out automatically even in the case of a bound document.

Desirably, the analysis device extracts at least one of text information, a figure and a photograph from the read image, as the original information, and the information processing device processes the original information extracted by the analysis device to generate the additional recording information.

According to this aspect of the invention, it is possible to judge the type of the contents of the printed document and to additionally record suitable information.

Desirably, the document processing apparatus further comprises a device which extracts key information from the original information, wherein the information processing device generates additional information which indicates the key information on the printed s document, and wherein the printing device records the additional information.

According to this aspect of the invention, it is possible to identify and extract key information from the contents of the printed document and to highlight this key information in a readily visible fashion by means of additional information.

Desirably, the document processing apparatus further comprises a device which extracts key information from the original information, wherein the information processing device generates an abstract text including the key information, and wherein the printing device additionally records the abstract text.

According to this aspect of the invention, it is possible to enable a user to ascertain the contents of the printed document in a short period of time by identifying and extracting key information from the contents of the printed document to create an abstract text.

Desirably, the document processing apparatus further comprises a device which analyses a language of text information of the original information, wherein the information processing device translates the text information of the original information from an original language to another language to generate a translation text of the text information, and wherein the printing device additionally records the translation text of the text information.

According to this aspect of the invention, by translating and additionally recording the contents of the printed document, it is possible to read the printed document while comparing the original text with a translated text.

In order to attain an object described above, another aspect of the present invention is directed to a document processing method including: a reading step of optically reading in a printed document on which original information has been printed, to obtain a read image; an analysis step of analyzing the read image obtained in the reading step and classifying each part of the read image into the original information and a blank portion; an information processing step of processing the original information to generate additional recording information; an arrangement step of determining arrangement, on the printed document, of the additional recording information which is to be recorded additionally onto the printed document, according to analysis result of the analysis step; and an additional recording step of additionally recording the additional recording information onto the printed document according to the arrangement of the additional recording information determined in the arrangement step.

In order to attain an object described above, another aspect of the present invention is directed to a computer-readable medium storing instructions to cause a computer to execute at least a method comprising: a reading step of optically reading in a printed document on which original information has been printed, to obtain a read image; an analysis step of analyzing the read image obtained in the reading step and classifying each part of the read image into the original information and a blank portion; an information processing step of processing the original information to generate additional recording information; an arrangement step of determining arrangement, on the printed document, of the additional recording information which is to be recorded additionally onto the printed document, according to analysis result of the analysis step; and an additional recording step of additionally recording the additional recording information onto the printed document according to the arrangement of the additional recording information determined in the arrangement step.

According to the present invention, it is possible to present the user with valuable information relating to the contents of the printed document, as well as being able to prevent increase in the volume of printed documents and consumption of media.

### BRIEF DESCRIPTION OF THE DRAWINGS

The nature of this invention, as well as other objects and benefits thereof, will be explained in the following with reference to the accompanying drawings, in which like reference characters designate the same or similar parts throughout the figures and wherein:

FIG. 1 is a general schematic drawing of one example of a document processing apparatus relating to a first embodiment of the present invention;

FIG. 2 is a plan view perspective diagram showing one example of the general composition of a liquid ejection head;

FIG. 3 is a cross-sectional diagram along line 3-3 in FIG. 2;

FIG. 4 is a block diagram showing one example of the functional composition of a document processing apparatus relating to the first embodiment;

FIG. 5 is an illustrative diagram showing one example of a read image obtained by reading in a document optically;

FIG. 6 is an illustrative diagram showing an enlarged view of one figure section in FIG. 5;

FIG. 7 is an illustrative diagram showing one example of a histogram of each of the figure sections;

FIG. 8 is an illustrative diagram used to describe the detection of spaces between lines;

FIG. 9 is an illustrative diagram used to describe the spaces between lines which have been determined;

FIG. 10 is a general schematic drawing showing one example of the read image analysis result;

FIG. 11 is a general schematic drawing showing one example of a document before additional recording;

FIG. 12 is an illustrative diagram showing one example of a document after additional recording;

FIGS. 13A and 13B are illustrative diagrams used to describe the reprinting of original information;

FIG. 14 is an outline flowchart in the document processing apparatus according to the first embodiment;

FIG. 15 is a general schematic drawing showing one example of an erasure apparatus for returning to an original state;

FIG. 16 is a general schematic drawing of one example of a document processing apparatus relating to a second embodiment of the present invention;

FIG. 17 is a block diagram showing one example of the functional composition of a document processing apparatus relating to the second embodiment;

FIG. 18 is a general schematic drawing of one example of a document processing apparatus relating to a third embodiment of the present invention;

FIG. 19 is a block diagram showing one example of the functional composition of a document processing apparatus relating to the third embodiment; and

FIG. 20 is an outline flowchart used to describe ink switching and under layer treatment.

### DETAILED DESCRIPTION OF THE PREFERRED EMBODIMENTS

### First Embodiment

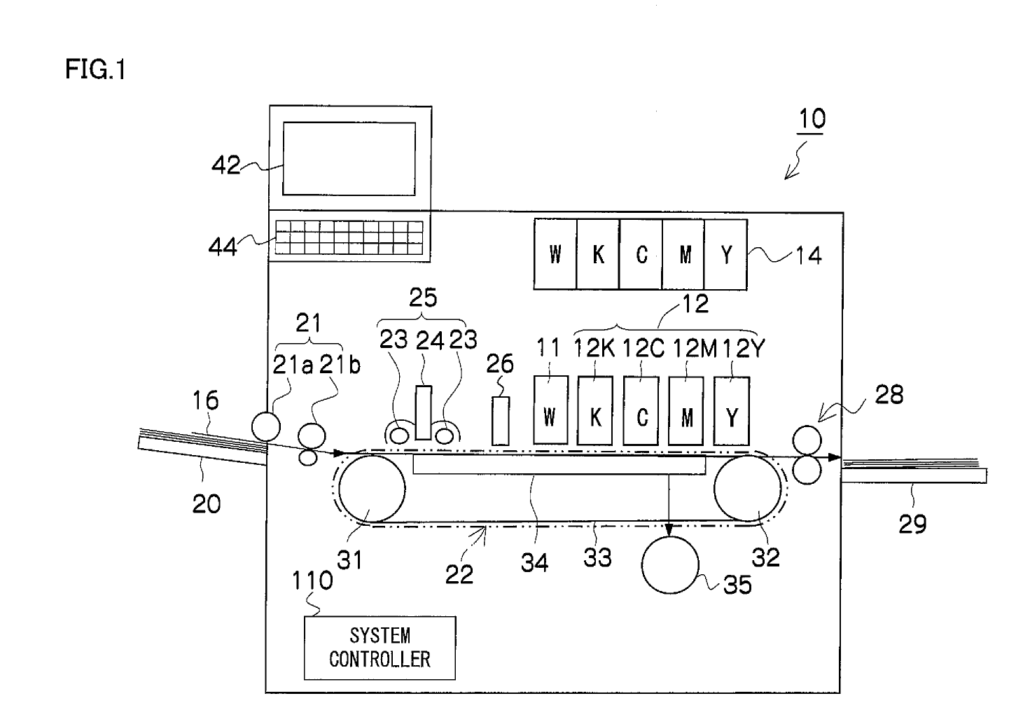

FIG. 1 is a general schematic drawing of one example of a document processing apparatus relating to a first embodiment of the present invention.

In FIG. 1, the document processing apparatus 10 comprises an overcoating liquid ejection head 11, ink ejection heads 12, a liquid storage unit 14, a paper supply tray 20, a paper supply unit 21, a suction conveyance unit 22, an image reading unit 25, a paper output unit 28 and a paper output tray 29.

In the present embodiment, the image reading unit 25 comprises lamps 23 which irradiate light onto the reading object sections of the document 16 onto which information has been printed, and a scanner 24 which scans and optically reads in the reading object sections of the document 16. The scanner 24 is constituted by a CCD (Charge Coupled Device) sensor, for example.

The overcoating liquid ejection head 11 ejects overcoating liquid for erasing by overcoating the original information on the document 16 (namely, the information which has already been printed onto the document 16). In the present example, the ink ejection heads 12K, 12C, 12M and 12Y respectively ejects a black ink, a cyan ink, a magenta ink, and a yellow ink. In the present embodiment, the liquid storage unit 14 is constituted by an overcoating liquid tank which stores overcoating liquid, and ink tanks which respectively store black ink, cyan ink, magenta ink and yellow ink.

The paper supply tray 20 contains a single sheet document 16 which is the object for processing. Furthermore, the paper supply unit 21 is constituted by an automatic sheet feeder comprising a supplying roller 21a and a feed roller 21b, and the single sheet document 16 is taken up from the paper supply tray 20 and supplied to the reading position of the image reading unit 25 (a position opposing the scanner 24), one sheet at a time.

The suction conveyance unit 22 has a structure in which an endless belt 33 is wound between conveyance rollers 31 and 32, and at least the surface of the belt which opposes the image reading surface of the image reading unit 25 and the liquid ejection surface of the liquid ejection beads 11 and 12 is constituted by a flat surface having a plurality of suction holes (omitted from the drawings). A suction chamber 34 is provided on the inner circumferential side of the belt 33 at a position opposing the image reading surface of the image reading unit 25 and the liquid ejection surface of the liquid ejection heads 11 and 12, and the document 16 is suctioned onto the belt 33 by putting this suction chamber 34 into the status of a negative pressure created by suctioning with a fan 35. By transmitting the motive force of a motor (not illustrated) to at least one of the rollers 31 and 32 about which the belt 33 is wound, the belt 33 is driven in the clockwise direction in FIG. 1 and the document 16 held on the belt 33 is conveyed from left to right in FIG. 1. When the leading edge portion of the document 16 conveyed by the suction conveyance unit 22 has been detected and registered in position by a positioning sensor 26, overcoating is carried out in accordance with requirements by the overcoating liquid ejection head 11, additional recording is performed by the ink ejection heads 12, and the document 16 is then output to the paper output tray 29 by the paper output unit 28. The positioning sensor 26 is constituted by an optical sensor, for example. In the present embodiment, the paper output unit 28 has a pair of rollers.

In FIG. 1, a case is shown where a single sheet document 16 is supplied from the paper supply tray 20 and is output to the paper output tray 29, but in a case where a bound document (such as a brochure or book) which requires page turning, the pages are turned by an optional page turning apparatus (not illustrated) and are thereby set to a state which can be read by the image reading unit 25. In a case of a bound document, the steps of optical reading, required overcoating and additional recording are carried out by moving a unit (reading and printing unit) which comprises the image reading unit 25, the positioning sensor 26 and the liquid ejection heads 11 and 12, in an integrated fashion.

Furthermore, the document processing apparatus 10 according to the present embodiment comprises a display monitor 42 and a keyboard 44. The display monitor 42 is constituted by a liquid crystal display apparatus (LCD) and a touch panel.

The document processing apparatus 10 of this kind is overall controlled by a system controller 110 which is described below.

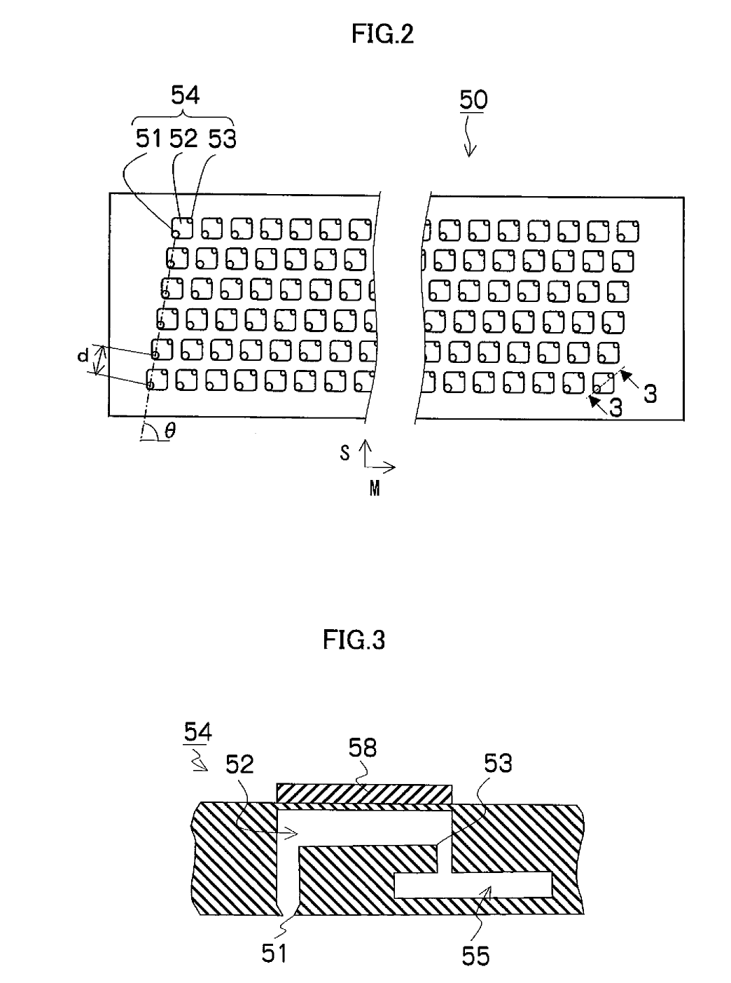

FIG. 2 is a plan view perspective diagram showing one example of the general composition of a liquid ejection head (hereinafter, called “head”) which is used as the overcoating liquid ejection head 11 and the ink ejection heads 12 illustrated in FIG. 1.

The head 50 in FIG. 2 is a so-called full line head in which a plurality of nozzles 51 (liquid ejection ports) which eject droplets of ink toward an ejection receiving medium are arranged in a two-dimensional configuration through a length corresponding to the width of the ejection receiving medium in the direction perpendicular to the direction of conveyance (namely, the sub-scanning direction which is indicated by arrow S in FIG. 2) of the ejection receiving medium (document 16 in FIG. 1) (in other words, the nozzles 51 are arranged in the main scanning direction which is indicated by arrow M in FIG. 2).

The head 50 comprises a plurality of liquid ejection elements 54, each comprising a nozzle 51 which ejects liquid, a pressure chamber 52 connected to the nozzle 51, and a liquid supply port 53 for supplying liquid to the pressure chamber 52, the recording elements 54 being arranged in two directions, namely, in a main scanning direction M and an oblique direction forming a prescribed acute angle θ (where 0°<θ<90°) with respect to the main scanning direction M. In FIG. 2, in order to simplify the drawing, only a portion of the liquid ejection elements 54 are depicted in the drawing.

In specific terms, the nozzles 51 are arranged at a uniform pitch d in the direction forming the prescribed acute angle of θ with respect to the main scanning direction M, and hence the nozzle arrangement can be treated as equivalent to a configuration in which nozzles are arranged at an interval of d×cos θ in a single straight line following the main scanning direction M.

FIG. 3 is a cross-sectional diagram along line 3-3 in FIG. 2. FIG. 3 shows only one liquid ejection element 54, in order to simplify the illustration, but the actual head 50 is constituted by a plurality of liquid ejection elements 54 which are arranged in a two-dimensional configuration as illustrated in FIG. 2. More specifically, each liquid ejection element 54 comprises one nozzle 51, one pressure chamber 52, one liquid supply port 53, and one piezoelectric element 58. By means of the piezoelectric element 58 changing the volume of the pressure chamber 52, liquid is caused to be ejected from the nozzle 51 which is connected to the pressure chamber 52. Furthermore, the pressure chambers 52 are connected to a common flow channel 55 which is common to the plurality of pressure chambers 52, via the liquid supply ports 53.

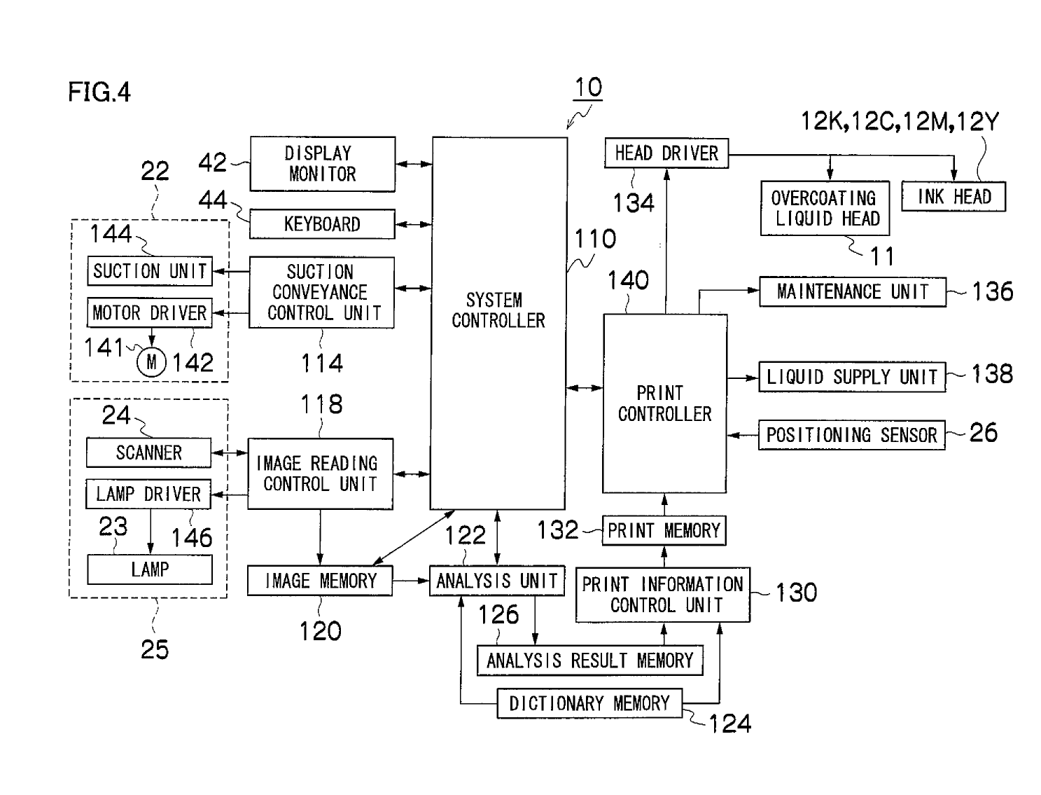

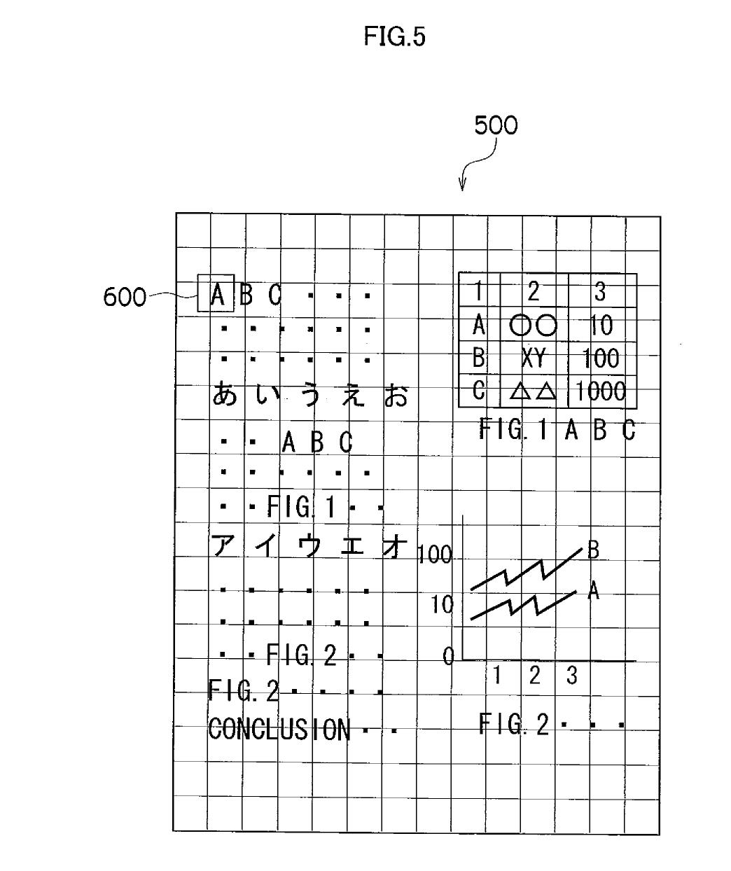

FIG. 4 is a block diagram showing one example of the functional composition of the document processing apparatus 10 illustrated in FIG. 1.

In FIG. 4, the document processing apparatus 10 principally comprises: the suction conveyance unit 22, the image reading unit 25, the display monitor 42, the keyboard 44, the system controller 110, a suction conveyance control unit 114, an image reading control unit 118, an analysis unit 122, a printing information control unit 130, a head driver 134, a maintenance unit 136, a liquid supply unit 138, a print controller 140, and memories of respective types 120, 124, 126 and 132.

The system controller 110 is constituted by a microcomputer and peripheral circuitry of same, and the whole of the document processing apparatus 10 is controlled on the basis of prescribed programs.

The suction conveyance unit 22 is constituted by a conveyance motor 141 which drives the conveyance rollers 31 and 32 in FIG. 1, a motor driver 142 which drives the conveyance motor 141, and a suction unit 144 which suctions the document 16, and this suction conveyance unit 22 serves to suction and convey the document 16 that is to be processed. The suction unit 144 includes the suction chamber 34 and the fan 35 illustrated in FIG. 1.

The suction conveyance control unit 114 is constituted by a microcomputer and peripheral circuitry thereof, and controls the suction conveyance unit 22 in accordance with instructions from the system controller 110.

The image reading unit 25 includes the lamps 23 in FIG. 1, a lamp driver 146 which drives the lamps 23, and the scanner 24 in FIG. 1, and the image reading unit 25 generates a read image by optically reading in the document that is the object for processing.

The scanner 24 is not limited in particular to a paper conveyance type of apparatus, and it is also possible to use a flatbed type of scanner. In order to achieve high-speed processing, it is possible to employ a scanner which captures an image of the whole page of the document 16 in one scanning action, and it is also possible to employ a scanner which captures one page of the document 16 in a plurality of scanning actions. The document 16 may also be scanned manually. Whichever of these scanning methods is used, the original information such as text information, photographs, figures, and the like, which have been printed on the document 16 is read in optically. The optical system used for image reading may be one of various types of system, such as a close-contact type system using a Selfoc array or a system using an imaging lens, or the like.

Furthermore, in order to be able to perform continuous reading of a plurality of sheets, it is desirable to provide an automatic sheet feeder (reference numeral 21 in FIG. 1) and a page turning apparatus (not shown) which turns the pages of a bound document (such as a brochure or book) in an integrated fashion. Furthermore, it is more desirable that the automatic sheet feeder and the page turning apparatus should be used for both reading and printing, since this makes it possible to form the apparatus to a more compact size.

The image reading control unit 118 is constituted by a microcomputer and peripheral circuitry thereof, and the image reading unit 25 is controlled in accordance with instructions from the system controller 110.

The image memory 120 is a memory which temporarily stores the read image.

The analysis unit 122 carries out processing for classifying original information (text information, figures, photographs) that have already been printed on the document 16 and blank portions by analyzing the read image (hereinafter, called “read image analysis”), and processing for analyzing the contents of the original information printed onto the document 16 (hereinafter, called “original information analysis). These processes are described in detail below.

The dictionary memory 124 is a memory that stores various dictionaries, such as a language dictionary, which is used in analyzing the original information in the analysis unit 122.

The analysis result memory 126 is a memory which stores the analysis results of the analysis unit 122.

The print information control unit 130 carries out processing (hereinafter called “information processing”) for generating additional recording information by processing the original information on the basis of the result of the original information analysis performed by the analysis unit 122, and processing (hereinafter, called “arrangement”) for determining the arrangement of the additional recording information on the document 16 on the basis of the result of the read image analysis and the result of the information processing. These processes are described in detail below.

The print memory 132 is a memory which temporarily stores additional recording information that is to be added to the document 16 and arrangement information for this additional recording information. In cases where the original information is to be reprinted, it also stores the original information and the arrangement information for same.

The head driver 134 is constituted by a circuit which drives the heads (overcoating liquid ejection head 11 and ink ejection heads 12).

The maintenance unit 136 performs maintenance of the state of the heads 11 and 12. For example, it seals the ejection surface of the head and suctions liquid from the head, and so on.

The liquid supply unit 138 supplies liquid to each of the heads 11 and 12, from the liquid storage unit 14 in FIG. 1.

The print controller 140 is constituted by a microcomputer and peripheral circuitry of same, and it controls overcoating and addition of information, and the like, by means of the head driver 134 in accordance with instructions from the system controller 110. Furthermore, the print controller 140 controls maintenance by means of the maintenance unit 136, in accordance with instructions from the system controller 110.

Below, the analysis unit 122, the print information control unit 130 and the print controller 140, which are principal parts of the present document processing apparatus, will be described in detail.

Firstly, the “read image analysis” carried out by the analysis unit 122 will be described in detail.

The analysis unit 122 analyzes the image information (read image) obtained by reading out the whole surface of the page of the document, and acquires the original information (text information, figure, photograph, etc.) which has already been printed on the document, from the read image. Moreover, the analysis unit 122 determines the blank portion where information can be added on the document (the margins, spaces between lines, is and the like). Basically, analysis is performed by using the text information as a clue and the read image is classified into original information and blank portions. In other words, the read image is classified into continuous regions which contain pixels that constitute the original information such as text information, a figure, a photograph, or the like, and continuous regions based on the background density. Parts of the original information are classified and extracted into text information, figures, photographs, and the like.

Distinction between text information and other portions is made on the basis of the density distribution on the document. More specifically, when one page of the document is read in, firstly, a histogram is created in respect of the density values of the whole of the read image, taking the number of pixels at each density value as the frequency. In this histogram, the peak density in the vicinity of the lowest density value (white or weak density) is the density of the background of the target page (in other words, the color of the paper).

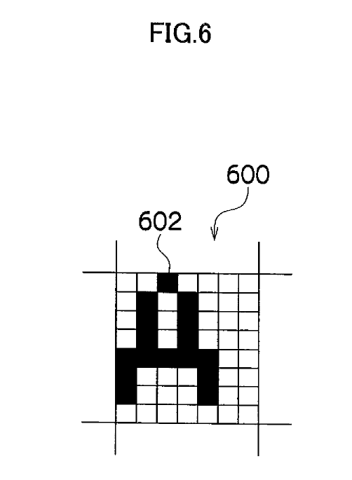

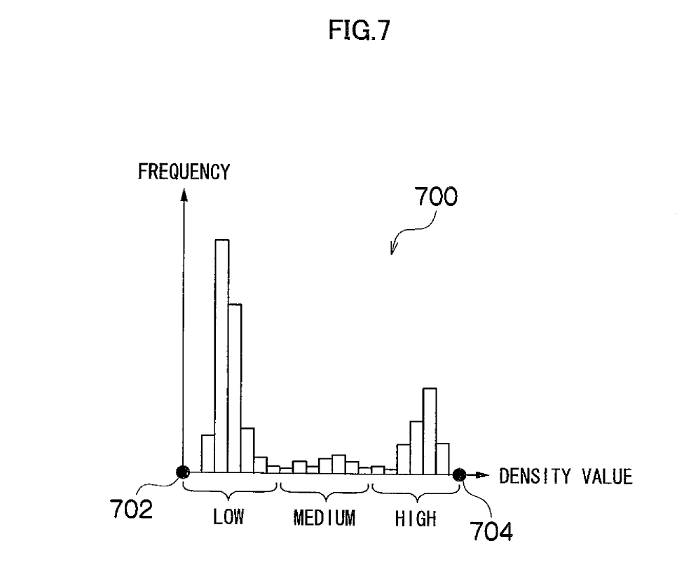

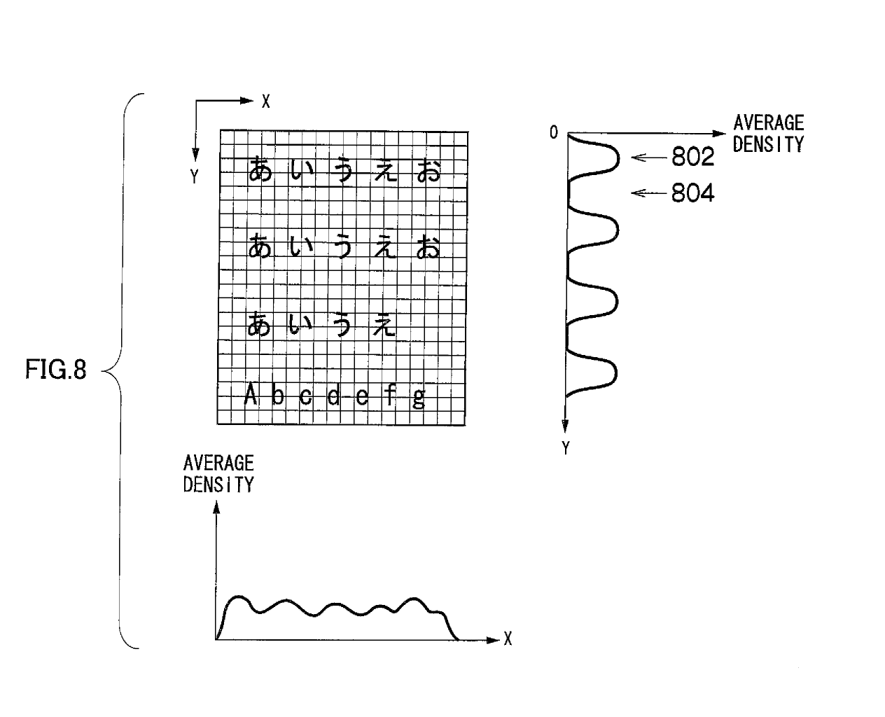

Next, as illustrated in FIG. 5, the read image 500 is divided into small figure sections 600 (for example, square shapes of approximately 2 cm×2 cm, an enlarged view of one example is illustrated in FIG. 6), and a histogram 700 is created for each of the sections 600 as illustrated in FIG. 7, by taking the number of pixels for each density value (602 in FIG. 6) as the frequency. Thereupon, the histogram 700 of the figure sections is divided into a portion where the density is higher than the background density and the density is relatively low (weak), a portion where the density is relatively high (dense), and a portion of medium density, and the frequency (number of pixels) in each of these respective portions is compared among these portions. In simple terms, as illustrated in FIG. 7, the range from the background density value 702 to the highest density 704 is divided equally into three density regions: “low”, “medium” and “high”, and the numbers of pixels in each of these regions are compared. As a result of this, a figure section 600 where the number of pixels in the “medium” density region is low and the number of pixels in the “high” density is large, in other words, a figure section 600 where the printed information has a high density contrast (clearly defined whites and blacks), is deduced to be a text information portion or a figure portion. The probability of this is particularly high if the “high” density region is a portion which is black in color.

The way in which the figure sections 600 having a high density contrast of this kind are connected in the vertical and horizontal directions in one page is then investigated and the scope of the range having similar characteristics is identified.

Next, as illustrated in FIG. 8, the average density in this range is determined in respect of the fineness (reading resolution) of the pixels in the read image, in both the vertical (Y axis) direction and the horizontal (X axis) direction. When the average density is determined in this way in portions where text is written, generally, a portion 802 of high average density corresponding to the width and height of text characters and a portion 804 having the background density of the paper (space between lines) are repeated at a certain frequency in terms of the horizontal direction in the case of a document with vertically arranged text and in terms of the vertical direction in the case of a document with horizontal arranged text. In a region where a portion 802 having a high average density is distributed in a periodic fashion, it is judged that text information is written, rather than a photograph or a figure. The space between lines 804 is determined by focusing on the compositional characteristics of the “lines”.

Since the period depends on the size of the text, as described above, then the periods corresponding to font sizes from point 6 to point 20 which are generally used in documents are taken as the basis for analysis. There is a possibility that larger text characters may be used in headline portions, or the like, and therefore portions exceeding a period corresponding to 20 point are also used as candidate for text information portions when the following processing is carried out.

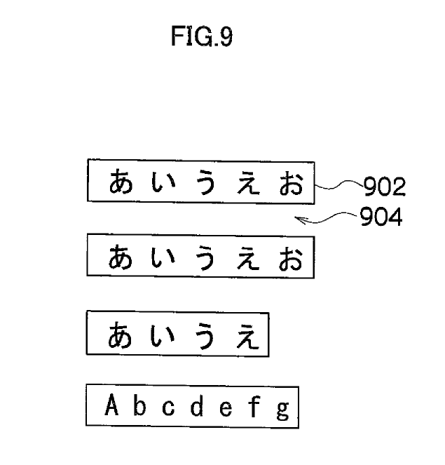

Moreover, the text information portion is judged to be horizontally arranged text in cases where the direction of repetition of the high-density portion and the background density portion is in the vertical direction, and is judged to be vertically arranged text in cases where the direction of repetition of the high-density portion and the background density portion is in the horizontal direction. Furthermore, the portions where there is continuous background density are judged to be spaces between lines. FIG. 9 shows a detected line 902 and a space 904 between lines which is a candidate for additional recording, as a result of the judgment of vertical text arrangement and horizontal text arrangement, and the judgment of the text positions and the spaces between lines.

If the pitch between text characters is not uniform (as in the ease of proportionally spaced printing, or the like), then the background density is liable to not appear in the row direction, and therefore it is easy to judge between horizontally arranged text and vertical arranged text. Even if this is not the case, then it is possible to judge between horizontally arranged text and vertically arranged text on the basis of the relationship between the pitch between characters and the pitch between lines, and the like.

In regions other than these, picture sections which have a high density contrast and do not have a periodic density variation as in the case of text characters are judged to be figures. Furthermore, picture sections having a large number of pixels of medium density on the basis of the histogram 700 for the respective picture sections 600 are judged to be a photograph. In this way, the type of original information is classified (into text information, figure, photograph, and the like), for each of the picture sections 600.

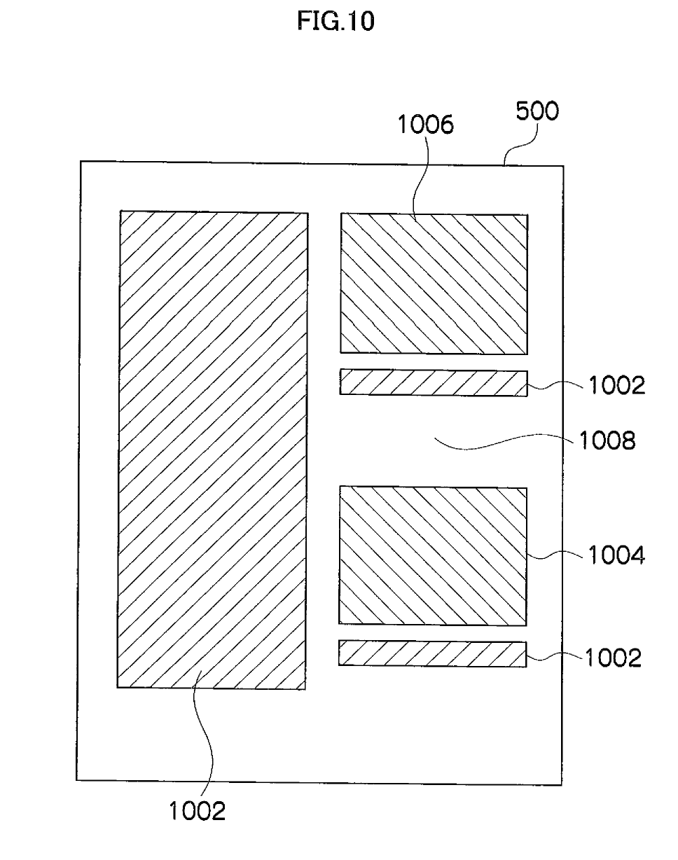

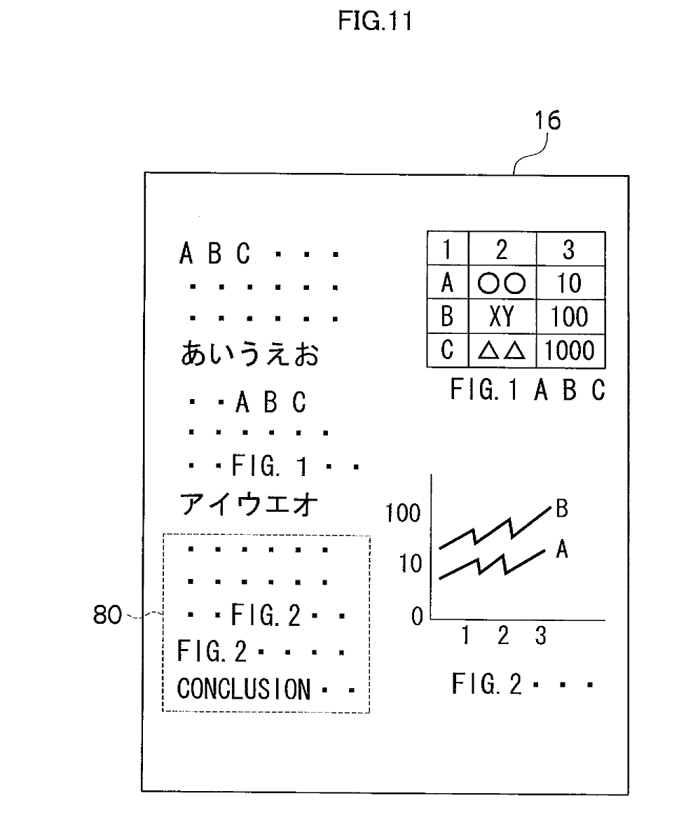

FIG. 10 shows the results of analyzing the read image 500 in FIG. 5. The portions indicated by the reference numeral 1002 are text information portions, the portion indicated by the reference numeral 1004 is a figure portion, the portion indicated by the reference numeral 1006 is a portion where text information and a figure are combined, and the portion other than these is a blank space 1008. Although not shown in the drawings, spaces between lines (904 in FIG. 9) which are detected as described above are present in the text information portion 1002.

Next, the analysis of the original information performed by the analysis unit 122 will be described.

The text information is converted to text character code by processing the text image using commonly known OCR (Optical Character Recognition) technology. In this, the size of the text characters, the thickness of the character lines, and the presence of text styles (underline, etc.) are determined. Moreover, the connections of the text passage are judged, on the basis of the determination results in relation to the arrangement the positional relationship of the text portion within one page and whether each text portion is vertically arranged text or horizontally arranged text. The connection of text passages is determined in accordance with general document layout rules, progressing downward starting from the top left in the case of horizontally arranged text, and furthermore linking to the top right and progressing downward again in the case of multiple column text, the text information being extracted accordingly as a continuous text passage. In the case of a multiple-page document, the analysis results of text information for previous and succeeding pages are combined when processing a continuous passage.

After extracting the text information as a text passage (hereinafter, simply called “passage”) as described above, the words inside the passage are analyzed.

In this analysis, firstly, the text passage is divided into words. If the text passage is divided into words, then firstly, divisions are made on the basis of the punctuation symbols, such as “,”, “.”, “;”, “:”, “,” and “°”, and blank spaces; and divisions are then made for blocks of hiragana (Japanese syllabary characters, such as [symbol] and [symbol] , for example), katakana (the angular Japanese phonetic syllabary, such as [symbol] and [symbol] , for example), kanji (Chinese character, such as [symbol] and [symbol] , for example), numerical figures, and letters of the alphabet. Thereupon, the words are compared with a dictionary which stores words of the language in question (a language dictionary which stores a plurality of words as in a standard language dictionary) and the words which are in the dictionary are extracted. If there is hiragana following a kanji character, then the word is compared with the words in the dictionary by supposing a case where there is okurigana (declensional Kana ending, which is used in Japan) and a case where there is no okurigana. As a result of this comparison, it is possible to divide the each block into even smaller divisions. For example, portions which are written by using a large amount of hiragana may be divided into a plurality of words. Since the part of speech relating to the word is recorded in the dictionary, then investigation based on the part of speech is also carried out.

The text passage is divided up into words and after investigating the parts of speech, the appearance frequency of the same words is examined. In particular, a word having a high appearance frequency as a noun has a high probability of being a keyword, and therefore points are assigned to such words. Furthermore, a word in bold type, a word which is underlined, and a word which has a larger character size than other characters have a high probability of being a keyword, and therefore points are assigned to such words. Furthermore, in a long text passage, the upper portion (introductory portion) and the end portion of the document have a high probability of including important information, and therefore points are assigned to these portions. Moreover, text which includes words relating to a conclusion, such as “result”, “in conclusion”, “conclusion”, “summary”, “consequently”, “because”, “finally”, “synopsis”, and the like, has a high probability of being a key phrase, and therefore points are assigned to such text. Furthermore, if a keyword is included in these passages, then there is an even higher probability of the text being a key phrase, and therefore further points are assigned.

In this way, points are assigned to each of the words and text passages, words and passages having high point scores are identified, and keywords and key phrases are thus extracted automatically as key information.

Furthermore, a user who is operating the present apparatus may enter a keyword which is under particular attention via the keyboard 44, or input a keyword by speech via a microphone (not illustrated). The image read in may be displayed on the display monitor 42, and a keyword may be input by being specified by means of a touch panel, or the like. A keyword which has been specified by the user in this way is treated as a top priority keyword.

After determining keywords as described above for each document, the positions of the keywords in one page are extracted from the text passage which is recognized previously.

Furthermore, in the case of figures or photographs, text describing the contents of same may be attached in the vicinity. In the analysis unit 122, particular attention is paid to text in the vicinity of, or directly above or directly below a figure or photograph of this kind, and keywords are extracted from this text in the manner described above. Since there is a particularly high probability that words (noun, etc.) which are present in the vicinity of an image or figure are important, then such words are judged to be key information.

Furthermore, if there is an annotation which indicates the number of a figure or the like, such as “FIG. 1” or “Figure 1”, then this number is associated with the number of the corresponding figure or the like in other text passages of the document. As a result of associating the numbers of the figures and the like in this way, then a figure or the like which is cited many times has a high probability of being important and therefore may be judged to be key information. More specifically, for example, if the number of associations exceeds an initially set threshold value, or exceeds a threshold value set by the user, then it is judged that the figure or the like assigned with that number is key information.

Next, the steps of “information processing” and “arrangement” carried out by the print information control unit 130 will be described in detail.

The print information control unit 130 generates additional recording information on the basis of the original information analysis result produced by the analysis unit 122, and determines the arrangement of the additional recording information into the blank portions (spare margins, spaces between lines) of the document 16 which is the source document.

For example, additional information is generated so as to indicate on the document 16 the key information (keywords, key phrases) which has been extracted by the analysis unit 122.

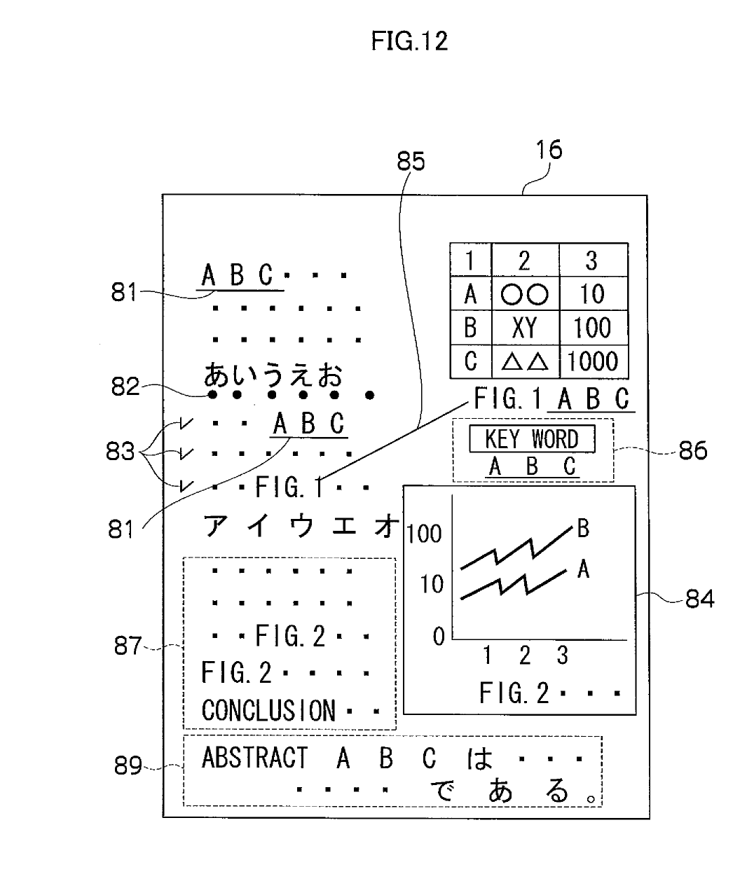

FIG. 11 shows a document 16 before additional recording and FIG. 12 shows a document 16 after additional recording. In FIG. 12, the keyword 86 is added to a blank margin. Possible examples of the additional information are a symbol such as an underlining 81, dotted line 82, or tick mark 83, or the like, which is added in the vicinity of the key information, or a round or square border frame 84 or the like which surrounds the key information. Furthermore, there is also a case where a line 85 (linking line) is generated which associates a figure number in the text information in the vicinity of a figure with the figure number in other text information.

The method of adding information is set in advance by the user. For instance, the additional recording information can be set by altering the color of the additional information (underlining, etc.) for each keyword, or by altering the type of additional information. Of course, it is also possible to following the standard settings of the apparatus.

Furthermore, it is also possible to add the keyword 86 which has been extracted as the most important keyword. In order to append additional recording information of this kind in a clearly discernable fashion, the surface area and width of the blank margins and spaces between the lines are determined from the read image, and the size of the additional recording information is determined in such a manner that a suitable margin is left (namely, that a gap is left between the additional recording information and the original information situated about the periphery thereof). It is possible to set the minimum possible size for this gap.

However, depending on the designated method for appending information, there are cases where the blank margins are insufficient and it is difficult to append information. If it is not possible to add the information even if the minimum gap is employed, then it is decided to reprint either a portion or all of the original information in order to create a suitable blank margin

In FIG. 12, the reference numeral 87 shows the original information that has been reprinted. This is information which has been reprinted using the same contents as the original information 80 in FIG. 11 and over a smaller print surface area (reprint surface area) than the print surface area of the original information 80 in FIG. 11. Before this reprinting process, a region of necessary surface area in the print region of the original information 80 in FIG. 11 is overwritten by using the previously determined background color or a color close to this (in general, white), thereby making the original information in this region invisible. In this overcoating process, a graduation in the amount of overcoating liquid is applied in the edge portions of the overcoating region (for example, the print region of the original information 80 in FIG. 11) so as to progressively reduce the amount of overcoating liquid toward the outer sides in order that the boundary portions between the overcoating region and the background color are not readily discernable.

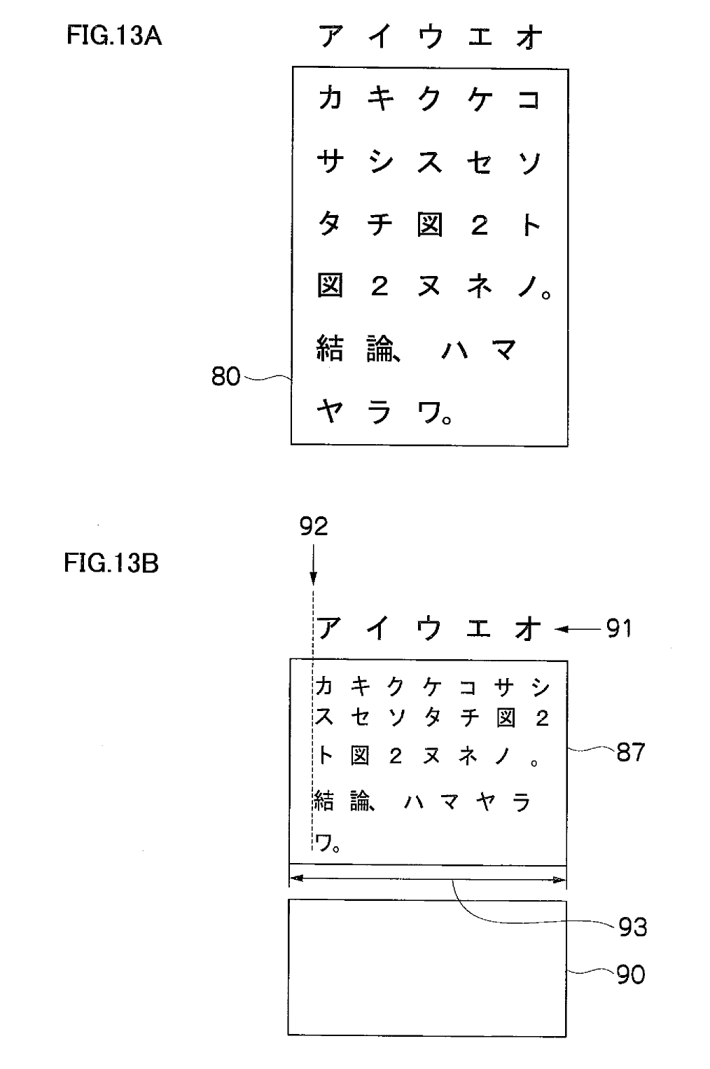

Furthermore, as illustrated in FIGS. 13A and 13B, processing and arrangement are carried out, for instance, so as to close up the spaces between the lines by altering the line pitch between the initial original information 80 and original information 87 after reprinting, thereby creating a new blank margin 90 for printing the additional recording information. This can be achieved in a straightforward fashion by reprinting the image of the original information at a reduced size. The overcoating and original information reprinting steps are carried out by control performed by the print controller 140 which is described below.

Furthermore, during reprinting, as illustrated in FIG. 13B, the line start positions 92 are aligned between the original information 87 which is reprinted and the original information 80 which is not reprinted. Furthermore, when printing at reduced size, in addition to aligning the line start positions 92, the text pitch is changed so as to close up the space between characters, thereby increasing the number of text characters per line, and the line width 93 is made to coincide with that of the original information 91 which has not been reprinted. It is also possible to make the line start positions and the line widths coincide in the original information 80 before reprinting and the original information 87 after reprinting.

In reducing the size, the point shape is maintained in such a manner that the text characters do not become difficult to decipher. Furthermore, the size is reduced in such a manner that the characteristics of the character font (curl, changes in line thickness) are preserved.

Moreover, it is also possible for the user to select the option of either adding the extracted keywords, adding the keywords and appearance frequency, or adding a key phrase, or the like, to the margins outside the text columns.

Furthermore, a “tick” point (reference numeral 83 in FIG. 12) can be added as a highlighting mark which indicates the presence of a keyword in the side margin immediately beside the text line containing the keyword, in such a manner that attention is drawn to same.

The user is able to select various options in respect of the numbers of the figures (graph, table, diagram) in the document 16, namely, either to print them using a different color for each number, to enclose them with different types of border lines, to print them in the same color as the corresponding figure (graph, table, diagram) or to enclose them with the same type of line, and so on. It is possible to choose that key diagrams be surrounded by colored lines (reference numeral 84 in FIG. 12) in order that the key diagrams stand out even further.

Depending on the type of document, there may be holes or binding in the document, and therefore in cases such as these, the additional recording information is positioned in such a manner that it is not printed in the vicinity of the holes or the binding positions.

The print controller 140 prints the additional recording information at a prescribed position in a blank portion (the blank margins or between the lines) of the document 16, in accordance with the arrangement which has been specified by the printing information control unit 130. In this case, an end portion of the document 16 is determined by means of the positioning sensor 26 in such a manner that there is no positional divergence.

Information can be added by means of an electrophotographic method or a thermal transfer method, but since the document 16 forming the processing object may have various paper qualities and thicknesses, then it is desirable to use an inkjet method, which is highly adaptable to various types of media. Since the inkjet method is a non-contact recording method, then printing can be carried out regardless of the surface properties (indentations, etc.) of the print medium, which is even more desirable.

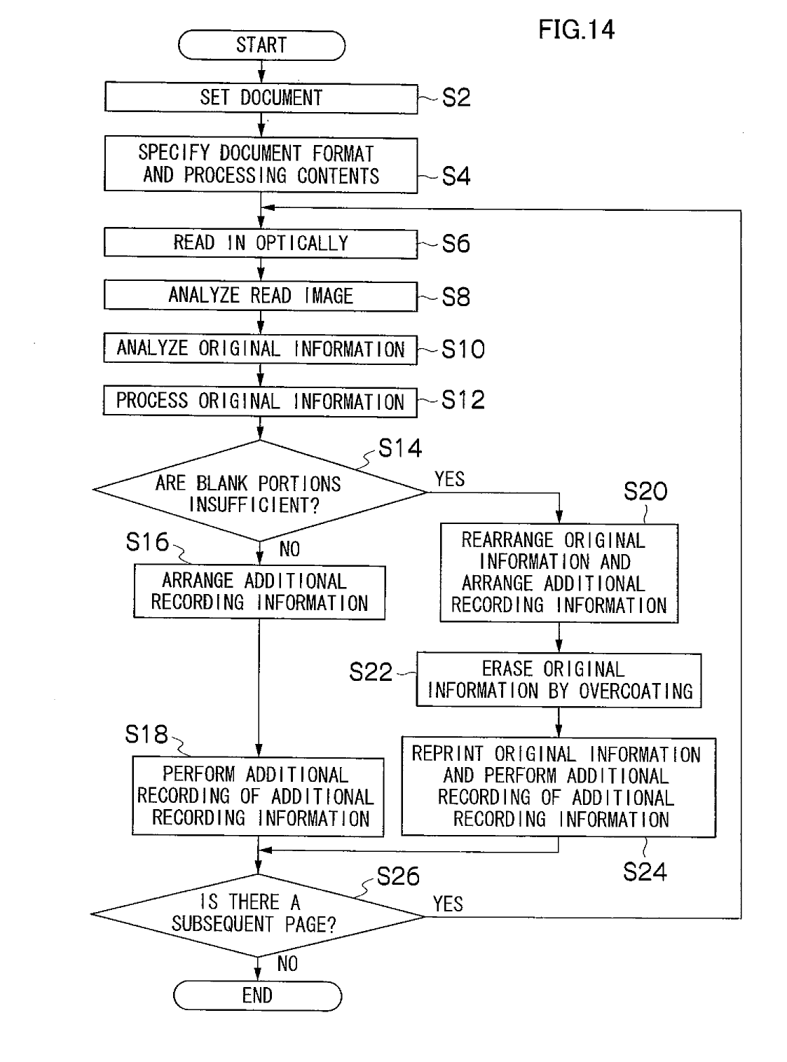

FIG. 14 is an outline flowchart showing one example of the flow of operations in the document processing apparatus 10 illustrated in FIG. 4. This operation is carried out under the overall control of the system controller 110, in accordance with programs.

Firstly, at step S2, a document 16 which is to be processed is set in the document processing apparatus 10 and at step S4, the document format and the processing details are specified and input. Possible document formats are: single sheet, bound medium (such as a brochure or book), and the like. In the present example, the user specifies and inputs the document format, but it is also possible to adopt a composition in which the document processing apparatus 10 determines the document format automatically. The user also specifies and inputs whether or not to process the rear surface of the document, and the page range from which page to which page is to be processed (designation of target pages). Furthermore, the user specifies and inputs the processing contents, such as the analysis of the original information, the information processing and the arrangement, and so on. The user specifies and inputs this information via the touch panel type of display monitor 42 or the keyboard 44, for example. Below, the processing contents which are specified and input are called “specified processing contents”.

Next, at step S6, the target page of the document 16 is set to a readable state in accordance with the document format and is read in optically by the image reading unit 25. For example, if the document is a single sheet document, then it is fed automatically to the reading position of the image reading unit 25 by means of the automatic sheet feeder (reference numeral 21 in FIG. 1), whereas if it is a bound medium which requires page turning, then the pages are turned automatically by using a page turning apparatus (not shown). It is also possible to set the target page to a readable status by manual operation performed by the user.

Next, at step 88, the read image is analyzed by the analysis unit 122 and is classified into original information portions (text information, figure, photograph, etc.) and blank portions (blank margins, spaces between lines, and the like).

Thereupon, at step S10, the original information is analyzed by the analysis unit 122 on the basis of the specified processing contents. For example, word analysis is carried out with respect to text information. The contents of the figure and the photograph are also analyzed in accordance with the specified processing contents. For example, in the case of a photograph, the subject of the photograph is analyzed.

Next, at step S12, the original information is processed in accordance with the specified processing contents by the print information control unit 130, and additional recording information is generated.

Next, at step S14, the print information control unit 130 judges whether or not the blank portions on the document 16 are insufficient in relation to the additional recording information.

If it is judged that the blank portions are sufficient, then at step S16, the arrangement of the additional recording information on the document 16 is determined on the basis of the analysis result of the analysis unit 122 and the information processing result of the print information control unit 130. The document 16 is conveyed by the suction conveyance unit 22 and is set to a printable state at step S16, and the additional recording information is added to the document 16 by the ink ejection heads 12 at step S18.

On the other hand, if it is judged that the blank portion is insufficient, then at step S20, reprinting of the original information is decided, and the arrangement of the original information (the movement source range and the movement destination position) are determined, in addition to which the additional recording information is rearranged. Here, the original information is arranged so as to be reprinted on a smaller print surface area than the original print surface area.

Next, at step S22, the document 16 is conveyed by the suction conveyance unit 22 and is set to an overwritable state, and the original information on the document 16 is erased by overcoating by using the overcoating liquid ejection head 11. Thereupon, at step S24, the document 16 is conveyed by the suction conveyance unit 22 and is set to a printable state, and the additional recording information is added to the document 16 by the ink ejection heads 12. Here, the original information is reprinted onto a smaller print surface area than the original print surface area, and therefore the blank portion becomes larger and the additional recording information can then be printed onto the blank portions.

It is not necessary to erase all of the original information, but rather it is sufficient to erase the original information in such a manner that the reprinting region for the original information and the additional recording region for the additional recording information are guaranteed. Here, the print surface area after the reprinting of the original information is smaller than the print surface area before erasure of the original information.

At step S26, it is judged whether or not there is a next page forming an object for processing, and if there is a next page, then the processing of this next page is started from step S6. In other words, a single-sheet document is fed to the reading position by means of an automatic sheet feeder, and a bound document has the pages turned by means of a page turning apparatus, and processing is then carried out from step S6. At step S26, if there is no subsequent page, then the present operation is terminated.

### Second Embodiment

There are cases where it is desired to erase the additional recording information and return the document to its original state, once a prescribed objective has been achieved. Therefore, in the present embodiment, a composition is adopted in which the additional recording information can be erased after being added. More specifically, overcoating and additional recording are carried out by using overcoating liquid and ink having an erasable color when in a dry state adhering to the document.

Here, erasure of the color of the ink means that the color of the ink in a dried state which is adhering to the document 16 disappears and the underlying surface (normally, the print medium) becomes visible. Furthermore, erasure of the color of the overcoating liquid means that the color of the overcoating liquid in a dried state which is adhering to the document 16 disappears and the underlying surface (normally, the print medium and the original information) becomes visible.

There are various types of liquid which have erasable color. Firstly, there are liquids which include a coloring material that loses its color spontaneously after a prescribed time period has elapsed. Secondly, there are liquids which include a coloring material that loses its color upon the application of heat. Thirdly, there are liquids which include a coloring material that loses its color upon the application of an erasing liquid. Fourthly, there are liquids which include a coloring material that loses its color as a result of a chemical reaction which occurs when irradiated with light (for example, ultraviolet light of a wavelength which is not included in the light of fluorescent lamps used generally for illumination purposes, or ultraviolet light of a short wavelength which has a weak intensity in the light used for illumination.)

The additional recording is performed by ejecting any one of these liquids having an erasable color selectively from the liquid ejection heads 11 and 12. In so doing, once the contents of the document have been understood, the additional recording information can be erased, and the document can be returned to its original state before the addition of information (returned to its original form), which is desirable.

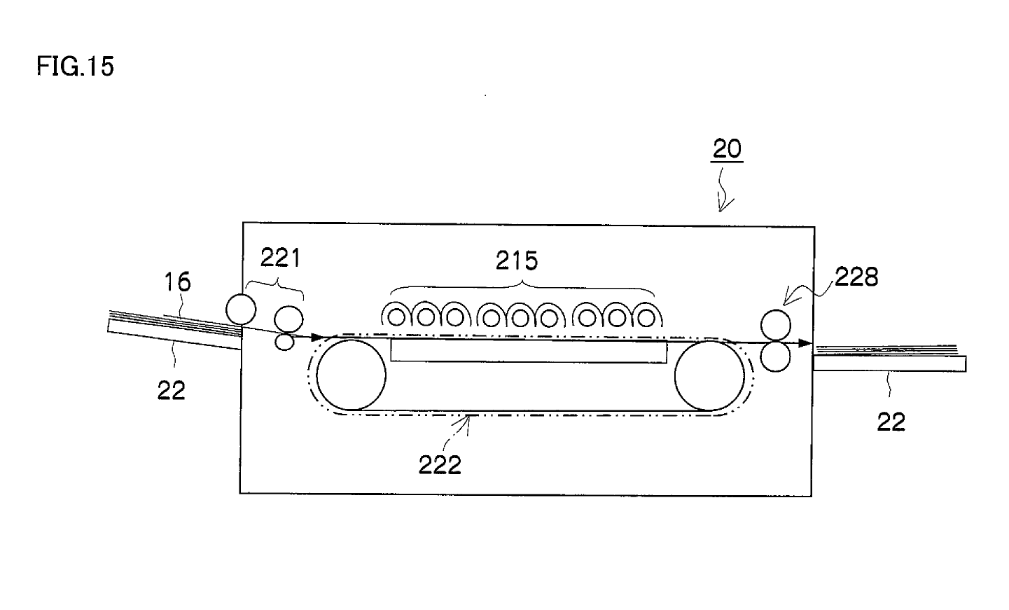

FIG. 15 is a general schematic drawing showing one example of an erasure apparatus 20 which can return the document 16 to its original form. In the present example, a single-sheet document 16 is taken as the object for processing.

In FIG. 15, the document 16 which is to be returned to its original form is installed in the paper supply tray 220. The additional recording information in this document 16 is printed with an ink that loses its color when irradiated with light. In the case of overcoating, an overcoating liquid which loses its color when irradiated with light is used. For instance, the ink and overcoating liquid lose their color when heated with an infrared beam or when ultraviolet light is irradiated thereon.

The document 16 on the paper supply tray 220 is supplied by a paper supply unit 221 and is conveyed to an irradiation position opposite an erasure lamp 215, by a conveyance unit 222. The erasure lamp 215 irradiates a prescribed light (for example, infrared light or ultraviolet light) onto the surface of the document 16. The color of the additional recording information on the document 16 is extinguished by the light from the erasure lamp 215 and the document 16 is output by a paper output unit 228 to a paper output tray 229.

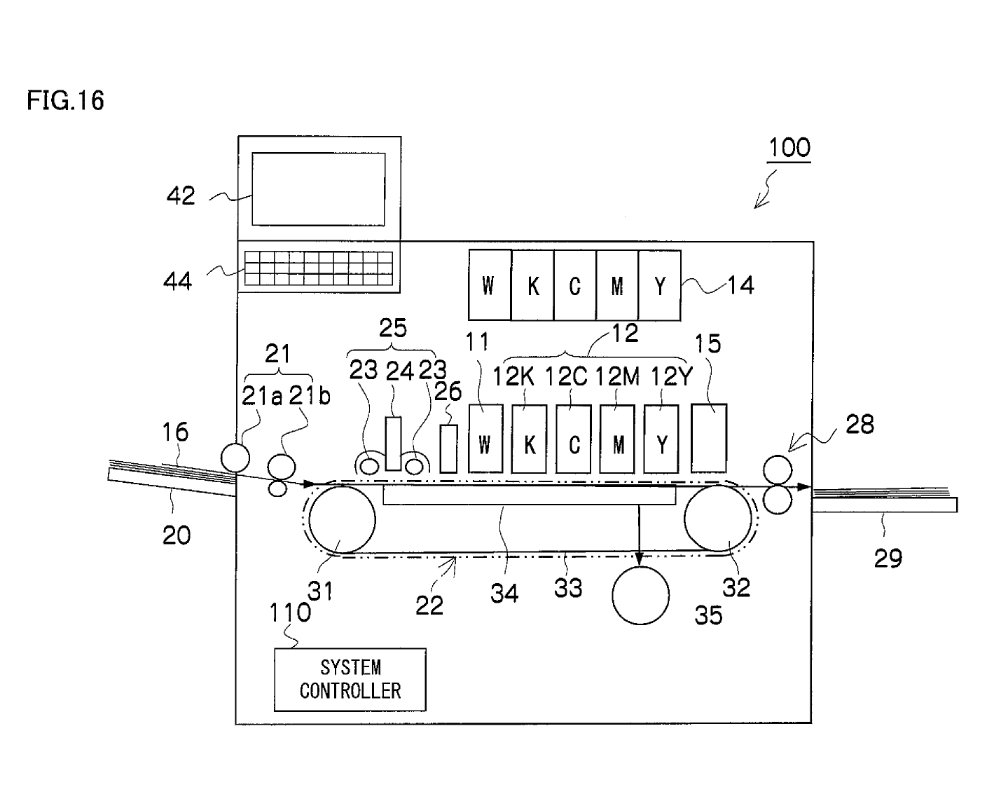

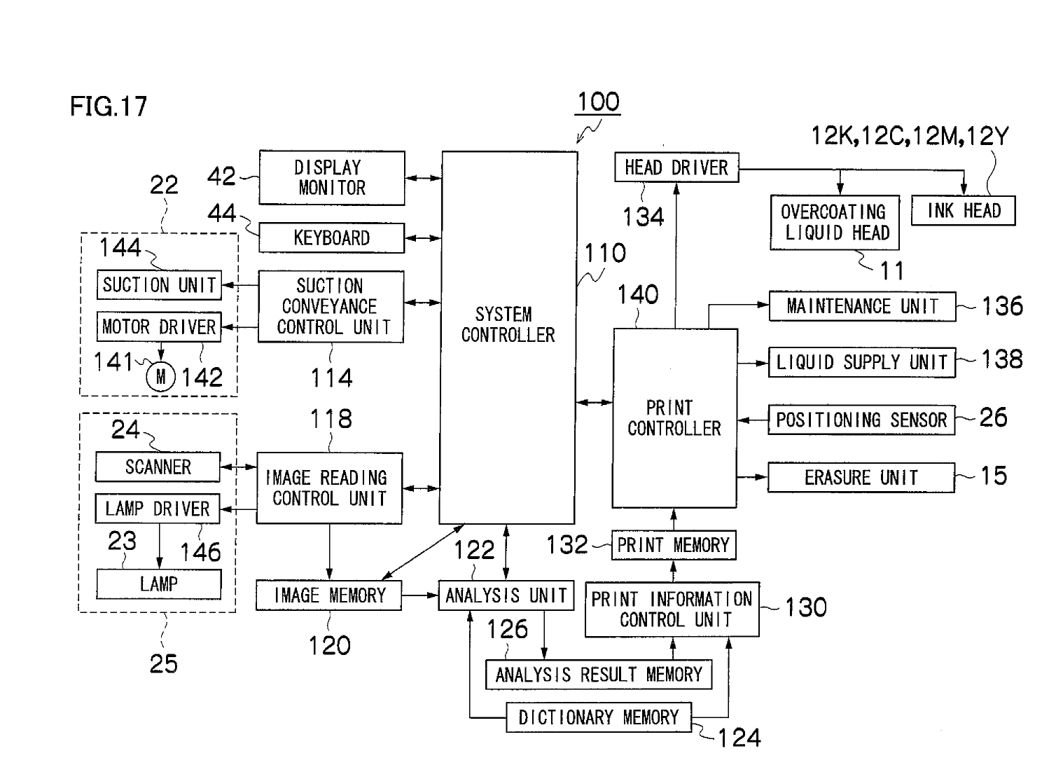

This description relates to a case which uses an apparatus that is separate from the document processing apparatus which prints additional recording information, hut it is also possible to use a document processing apparatus 100 which comprises an erasure unit 15 for returning the document 16 to the original form, as in the general schematic drawing in FIG. 16 and the block diagram in FIG. 17. The constituent elements other than the erasure unit 15 are the same as the document processing apparatus according to the first embodiment which is illustrated in FIG. 1 and FIG. 4, and contents which have already been described are not explained further here.

In FIG. 16 and FIG. 17, a document 16 which is to be returned to its original form is placed in the paper supply tray 20. The document 16 is supplied by the paper supply unit 21 and is conveyed by suction to a position which opposes the light irradiation surface of the erasure unit 15 by the suction conveyance unit 22. The erasure unit 15 irradiates light for extinguishing the color (for example, infrared beam for heating, ultraviolet light, etc.) onto the surface of the document 16.

Even if the additional recording information is erased as described above, when an image is captured by illuminating with infrared light or ultraviolet light, some of the ink used for adding information may remain and therefore the additional recording information which has been erased may still be readable in practice. Therefore, if the additional recording information and the peripheral region thereof are filled completely with the ink used for the additional recording firstly before erasing the additional information and the erasure process described above is then carried out subsequently by the erasure unit 15, then the additional recording information becomes difficult to read subsequently, which is desirable. Desirably, the ink used for this filling process can be ejected readily from the ink ejection heads 12 used for additional printing.

As a method for returning the document to its original form, rather than extinguishing the color of the ink and the overcoating liquid, it is also possible to erase the additional recording information by detachment.

For example, a monomer component which creates adhesive properties upon bonding and formation of a polymer, is added to the ink. This ink forms a polymer due to bonding of the monomer when the ink droplets dry after printing, and it adheres to the paper due to the resultant adhesive properties. If the adhesive force is made to be weak, then by applying a shearing force to the ink in a dried state, the ink can be detached easily. Alternatively, if printing is performed using a polymer which contracts when heat is applied, then by applying heat when it is wished to detach the ink, it is possible to generate a shearing force due to the contraction of the ink itself which is in a dried state, and hence the ink can be detached. Similarly to the ink, the overcoating liquid used is a liquid which can be detached from the document 16 when in a dried state after the addition of information.

In contrast to erasure, if information is added by using a fluorescent colored ink which becomes visible only when illuminated with ultraviolet light, such as a black light, or the like, normally it is not possible to discern the additional recording information, which is desirable.

Ink of this kind which is imparted with various properties can be ejected easily from a head and therefore is desirable.

### Third Embodiment

Depending on the type of medium used for the document 16, the ink used for additional recording may be difficult to fix. For example, there is a printed document which is smoothed by coating it with a UV-curable varnish. In cases such as this, for example, since the surface treatment of the medium is based on a resin film, then the type of ink is switched to an ink having good fixing properties with respect to resin, such as an oil-based ink or a UV ink.

With this method, the number of types of ink increases; therefore, as a further method, an under layer treatment liquid containing a binder component and an ink solidifying liquid which facilitate the fixing of the ink is deposited onto the range where information is to be added, before the additional recording information is printed. Desirably, this under layer treatment liquid is transparent.

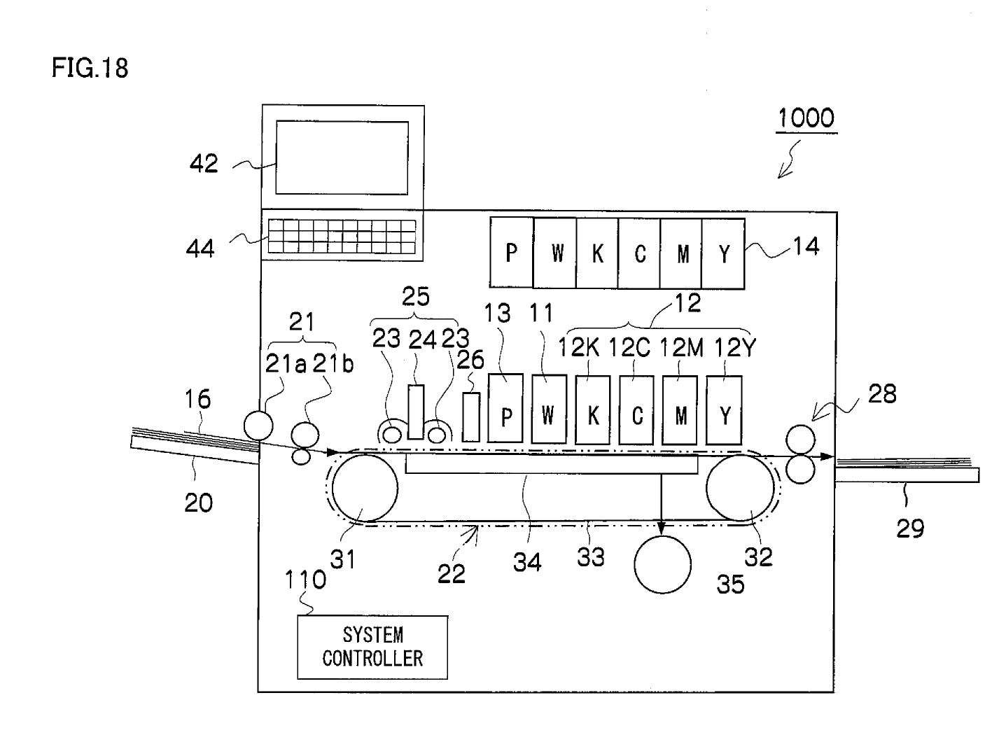

FIG. 18 is a general schematic drawing of one example of a document processing apparatus relating to a third embodiment. In FIG. 18, the same reference numerals are assigned to constituent elements which are the same as the constituent elements of the document processing apparatus 10 of the first embodiment which is illustrated in FIG. 1, and details which have already been described are not explained further here.

The document processing apparatus 1000 in FIG. 18 comprises an under layer treatment liquid ejection head 13 which ejects under layer treatment liquid. This under layer treatment liquid ejection head 13 is constituted by a head 50 as illustrated in FIG. 2 and FIG. 3, for example. Desirably, the under layer treatment liquid is deposited selectively only onto the range of the document 16 where information is to be added, by using a head 50 having a plurality of nozzles 51.

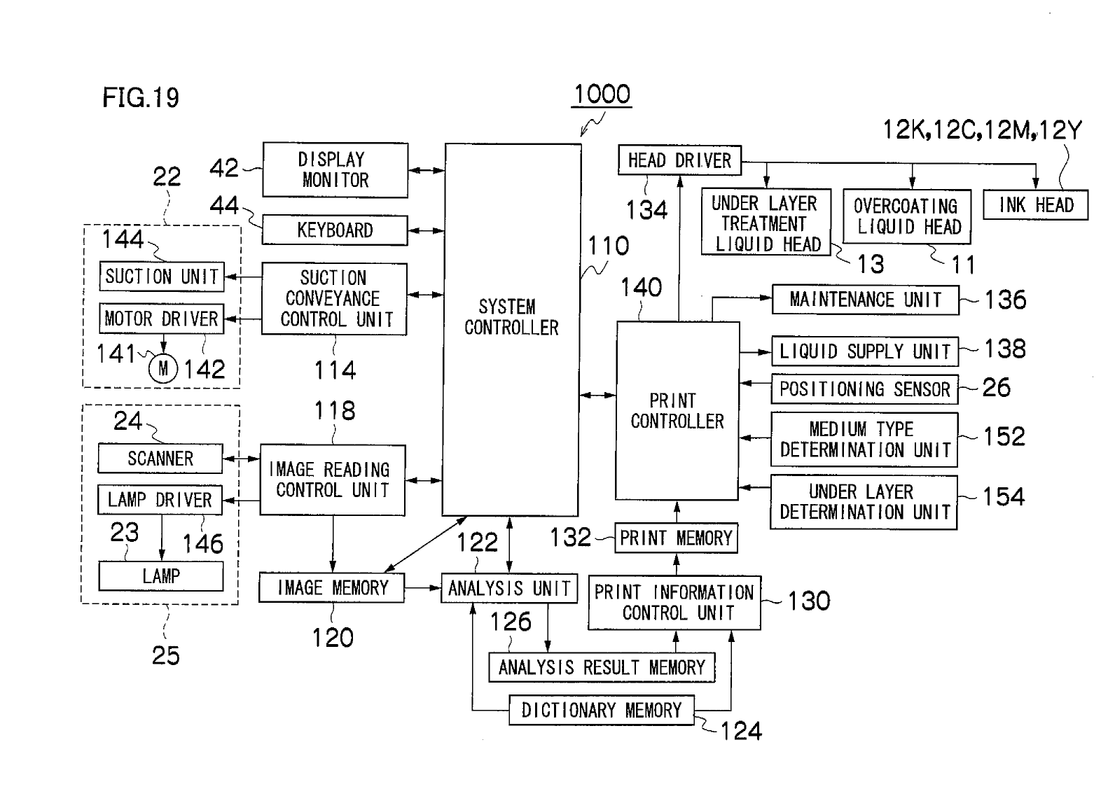

FIG. 19 is a block diagram showing one example of the functional composition of the document processing apparatus 1000 illustrated in FIG. 18. In FIG. 19, the same reference numerals are assigned to constituent elements which are the same as the constituent elements of the document processing apparatus 10 of the first embodiment which is illustrated in FIG. 4, and details which have already been described in respect of the first embodiment are not explained further here.

The document processing apparatus 1000 comprises a medium type determination unit 152 which determines the type of medium of the document 16. One mode for determining the type of medium is a mode where, for example, identification information previously applied to the document 16 is read in by the image reading unit 25 and the medium type is determined on the basis of this identification information, or a mode where the medium type is determined on the basis of information input via the display monitor 42 or keyboard 44.

The document processing apparatus 1000 comprises an under layer determination unit 154 which determines the quality of the surface of the document 16. A possible mode for determining the quality of the surface is a mode where the quality is determined, for example, on the basis of the medium type which has been determined as described above and table information which previously stores correspondences between the medium type and surface quality (the surface reflectivity of the medium, the spectral reflectivity corresponding to a color, the light diffusion characteristics: for example, in the case of light incident on the medium surface at an angle of 90 degrees, the ratio between the reflectivity of light returning in the direction of incidence and the reflectivity of light at an angle of 45 degrees), or a mode where the quality is determined on the basis of information input via the display monitor 42 or keyboard 44.

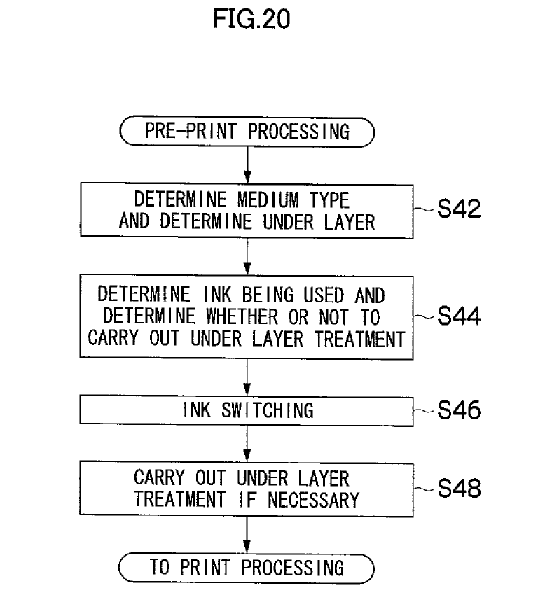

The sequence of operations in the document processing apparatus 1000 according to the present embodiment is described with reference to FIG. 14 and FIG. 20. These operations are carried out under the overall control of the system controller 110, in accordance with programs.

In the present embodiment, in the operational sequence illustrated in FIG. 14 which is described in respect of the first embodiment, the steps S42 to S48 illustrated in FIG. 20 are executed before executing printing (steps S18 and S24).

Firstly, at step S42, the type of paper constituting the document 16 (medium type) is determined by the medium type determination unit 152, and furthermore, the surface treatment (surface quality) of the document 16 is determined by the under layer determination unit 154. It is also possible to carry out either one of the medium type determination step or the under layer determination step, only.

At step S44, it is judged on the basis of the determination result from step S42 whether or not to carry out determination of the ink used and whether or not to carry out under layer treatment. It is also possible to carry out only one step of either the determination of the ink used, or the determination of whether or not under layer treatment is necessary.

At step S46, the type of ink is switched by a switching process of the liquid supply unit 138 on the basis of the determination in step S44, and at step S48, if necessary, under layer treatment is carried out by a switching process of the print controller 140. It is also possible to carry out only one of ink type switching or under layer treatment. Of course, if both the medium type and the surface quality are favorable, then neither ink type switching nor under layer treatment are carried out.

Thereupon, printing of the additional recording information is carried out (steps S18 and S24 in FIG. 14).

In the present example, the type of ink used for additional recording is switched by the liquid supply unit 138 on the basis of the determination result of the medium type determination unit 152 and/or the under layer determination unit 154. Furthermore, the surface of the document 16 is improved by applying an under layer treatment liquid which raises the fixing properties of the ink used for additional recording with respect to the surface of the document 16 by means of an under layer treatment liquid ejection head 13. Subsequently, the additional information is printed.

Switching of the ink type and selective deposition of the under layer treatment liquid can both be achieved readily by using a head, which is desirable.

An example is described here where both a medium type determination unit 152 and an under layer determination unit 154 are provided, but it is also possible to provide either one of these units only.

### Fourth Embodiment

The document processing apparatus according to the present embodiment is described below with respect to FIG. 4. Contents which have already been described in reference to the first embodiment are not explained further here.

In the present embodiment, the analysis unit 122 extracts key information (keyword, key phrase) from the text information (hereinafter, “original text”) which has been subjected to text character recognition by reading in from the document 16, and the print information control unit 130 creates an abstract text which includes the key information. The abstract text thus created is recorded additionally onto blank margins of the document 16 under the control of the print control unit 140.

The print information control unit 130 creates an abstract text in accordance with an instruction from a user input via the keyboard (instruction input device). For example, the volume of the abstract text (for example, the number of characters in same) can be specified and input by this means.

If the abstract text does not fit into the blank margins of the document, then the original text is reprinted on a print surface area that is smaller than the original print surface area, as described previously in relation to the first embodiment, whereupon the abstract text is added to the blank margins which have thus been enlarged. It is also possible to record the abstract text onto a margin of enlarged surface area by moving the original text. It is also possible to record the additional information by shortening the abstract text further.

The abstract text is created by extracting a keyword from the original text and using a text containing such a keyword to create the abstract text. It is possible to extract such a keyword as described previously in respect of the first embodiment. It is also possible to create the full text of the abstract text by extracting an individual text which includes the extracted keyword from the original text.

### Fifth Embodiment

The document processing apparatus according to the present embodiment is described below with reference to FIG. 4. Contents which have already been described in relation to the first embodiment are not explained further here.

In the present embodiment, the print information control unit 130 translates the text information (original text) which has been subjected to text character recognition by reading from the document, from the original language (for example, English) to a target language (for example, Japanese), by using a translation dictionary inside the dictionary memory 124. The translation results are recorded additionally onto the document 16 under the control of the print controller 140.

The print information control unit 130 carries out translation in accordance with an instruction from a user input via the keyboard (instruction input device). For example, by this means, it is possible to instruct whether or not to carry out translation, and to specify the original language and the target language. Furthermore, it is possible to instruct and input the additional recording format to be used for the translation result.

Here, the additional recording format may be, for example, additional recording of the whole of the translation result (translated text) in the spaces between the lines, or additional recording of a sentence which summarizes the translation result (abstract text) into the blank margins, or the like.

Furthermore, it is also possible to adopt a mode in which individual words are recorded in the dictionary memory 124 in association with their difficulty (information indicating the level of difficulty of the word), and with respect to only in the case of words having a level of difficulty which exceeds a threshold value, translated words are recorded additionally between the lines.

The settings of the translation function (whether or not to carry out translation, the languages, the additional recording format, and so on) are not limited in particular to being instructed by the user, and these settings may also be determined automatically by the system controller 110 on the basis of the results of the analysis (read image analysis and original information analysis) performed by the analysis unit 122.

The present invention is not limited to the examples described in the present specification and shown in the drawings, and various design modifications and improvements may of course be implemented without departing from the scope of the present invention.

It should be understood that there is no intention to limit the invention to the specific forms disclosed, but on the contrary, the invention is to cover all modifications, alternate constructions and equivalents falling within the spirit and scope of the invention as expressed in the appended claims.

What is claimed is:

1. A document processing apparatus comprising:
a reading device which optically reads in a printed document on which original information has been printed, to obtain a read image;
an analysis device which analyses the read image obtained by the reading device and classifies each part of the read image into the original information and a blank portion;
an information processing device which processes the original information to generate additional recording information;
an arrangement device which determines arrangement, on the printed document, of the additional recording information which is to be recorded additionally onto the printed document, according to analysis result of the analysis device; and
a printing device which additionally records the additional recording information onto the printed document according to the arrangement of the additional recording information determined by the arrangement device.

2. The document processing apparatus as defined in claim 1, further comprising:
an overcoating device which erases the original information on the printed document by overcoating; and
a control device which implements control to erase the original information on an original print surface area of the printed document by means of the overcoating device and reprint the original information over a reprint surface area of the printed document that is smaller than the original print surface area by means of the printing device in such a manner that the blank portion is enlarged, if the blank portion on the printed document is insufficient for the additional recording information.

3. The document processing apparatus as defined in claim 2, wherein when the original information includes a portion to be reprinted and a portion to be not reprinted, the arrangement device aligns a line start position and a line width of the original information between the portion to be reprinted and the portion to be not reprinted.

4. The document processing apparatus as defined in claim 2, wherein the overcoating device comprises a liquid ejection head having a plurality of ejection ports ejecting an overcoating liquid.

5. The document processing apparatus as defined in claim 1, wherein the printing device uses a liquid that has an erasable color on the printed document, to print the additional recording information.

6. The document processing apparatus as defined in claim 2, wherein the overcoating device and the printing device use a liquid that has an erasable color on the printed document, to perform additional recording of the additional recording information.

7. The document processing apparatus as defined in claim 5, wherein the printing device fills the additional recording information and a peripheral region of the additional recording information with the liquid having an erasable color, before erasure of the additional recording information.

8. The document processing apparatus as defined in claim 1, wherein the printing device uses an ink which can be detached from the printed document after additional recording, to record the additional recording information.

9. The document processing apparatus as defined in claim 1, wherein the printing device uses an ink which becomes visible when the ink is radiated by ultraviolet light after additional recording, to record the additional recording information.

10. The document processing apparatus as defined in claim 1, further comprising:
a determination device which determines medium type or surface quality of the printed document; and
a switching device which switches type of liquid used for recording of the additional recording information, according to determination result of the determination device.

11. The document processing apparatus as defined in claim 1, further comprising:
a determination device which determines medium type or surface quality of the printed document;
an under layer treatment liquid deposition device which deposits, onto a surface of the printed document, an under layer treatment liquid to enhance fixing properties of a liquid used for printing of the additional recording information; and
a switching device which switches whether or not to deposit the under layer treatment liquid onto the surface of the printed document, according to determination result of the determination device.

12. The document processing apparatus as defined in claim 1, further comprising an automatic sheet feeder and a page tuning apparatus,
wherein if the printed document is a single sheet document, then the automatic sheet feeder feeds the printed document to a reading position of the reading device, whereas if the printed document is a bound medium, then the page turning apparatus turns pages of the bound medium in such a manner that a target page is set to a state where it can be read by the reading device.

13. The document processing apparatus as defined in claim 1, wherein the analysis device extracts at least one of text information, a figure and a photograph from the read image, as the original information, and
the information processing device processes the original information extracted by the analysis device to generate the additional recording information.

14. The document processing apparatus as defined in claim 1, further comprising a device which extracts key information from the original information,
wherein the information processing device generates additional information which indicates the key information on the printed document, and
wherein the printing device records the additional information.

15. The document processing apparatus as defined in claim 1, further comprising a device which extracts key information from the original information,
wherein the information processing device generates an abstract text including the key information, and
wherein the printing device additionally records the abstract text.

16. The document processing apparatus as defined in claim 13 further comprising a device which analyses a language of text information of the original information,
wherein the information processing device translates the text information of the original information from an original language to another language to generate a translation text of the text information, and
wherein the printing device additionally records the translation text of the text information.

17. A document processing method including:
a reading step of optically reading in a printed document on which original information has been printed, to obtain a read image;
an analysis step of analyzing the read image obtained in the reading step and classifying each part of the read image into the original information and a blank portion;
an information processing step of processing the original information to generate additional recording information;
an arrangement step of determining arrangement, on the printed document, of the additional recording information which is to be recorded additionally onto the printed document, according to analysis result of the analysis step; and
an additional recording step of additionally recording the additional recording information onto the printed document according to the arrangement of the additional recording information determined in the arrangement step.

18. A computer-readable medium storing instructions to cause a computer to execute at least a method comprising:
a reading step of optically reading in a printed document on which original information has been printed, to obtain a read image;
an analysis step of analyzing the read image obtained in the reading step and classifying each part of the read image into the original information and a blank portion;
an information processing step of processing the original information to generate additional recording information;
an arrangement step of determining arrangement, on the printed document, of the additional recording information which is to be recorded additionally onto the printed document, according to analysis result of the analysis step; and
an additional recording step of additionally recording the additional recording information onto the printed document according to the arrangement of the additional recording information determined in the arrangement step.
